(19) United States
(12) Patent Application Publication
(10) Pub. No.: US 2006/0167713 A1
(43) Pub. Date: Jul. 27, 2006

(54) Automatic transmission for use with a power take-off device, and method of use

(76) Inventors: Anthony R. Johnson, Washington, IL (US); John M. Seipold, Glasford, IL (US); Kevin G. Meyer, Metamora, IL (US)

Correspondence Address: CATERPILLAR INC.;100 N.E. ADAMS STREET, PATENT DEPT., PEORIA, IL, 616296490, US

(21) Appl. No.: 11/273,808

(22) Filed: Nov. 15, 2005

Related U.S. Application Data
(63) Continuation-in-part of application No. 11/022,630, filed on Dec. 28, 2004.
(60) Provisional application No. 60/660,707, filed on Mar. 11, 2005.

(51) Int. Cl. G06Q 99/00

(52) U.S. Cl. 705/1

(57) ABSTRACT

An automatic transmission adapted to receive a power take-off device at a rear portion thereof and kit for providing power take-off components. Due to size constraints around an automatic transmission, a rear mounted power take-off device avoids the difficulties common to side mounted power take-offs. The automatic transmission includes a transmission housing with a front and rear portion, an input member, at least one planetary gear set driven by the input member, at least one brake or clutch adapted to change a gear ratio output from the transmission. A driven gear on a second axis of rotation intermeshes an input gear on a first axis of rotation. A flange on the rear portion of the transmission is configured to receive the power take-off device.

### RELATED APPLICATIONS

This application claims priority to U.S. application Ser. No. 11/022,630, entitled “Rear Power Takeoff” filed on Dec. 28, 2004, to John M. Seipold and Kevin G. Meyer, and U.S. Provisional Patent Application No. 60/660,707, entitled “Transmission Assembly”, filed on Mar. 11, 2005 to Anthony R. Johnson, John M. Seipold, and Kevin G. Meyer.

### TECHNICAL FIELD

The present invention relates to automatic transmissions and, more particularly, to enabling automatic transmissions to receive power take-off devices.

### BACKGROUND

Conventional work machines can be used in many different applications, including those in the areas of construction, agriculture, landscaping, and mining. To perform these applications, work components are typically connected to work machine lift arms or other articulated members, which are actuated by the work machine's auxiliary hydraulic circuit. For example, an auxiliary hydraulic circuit may include an auxiliary pump configured to supply fluid to the articulated members to effectuate movement of the members.

In some work machines, the transmission may be used to drive the auxiliary hydraulic circuit, such as a power take-off (“PTO”). The PTO drives the auxiliary pumps to assist in actuating the articulated members of the work machine. In many cases, the PTO is mounted directly to the transmission.

For example, U.S. Pat. No. 6,080,081 to Sauermann et al. provides a PTO control and illustrates a countershaft transmission with a PTO mounted to a rear portion of the transmission. Due to the plurality of available shafts in a countershaft transmission, attaching a PTO to a rear portion of the transmission has been widely adopted.

In contrast, automatic transmissions only use one shaft, which is in coaxial alignment with the input shaft, to drive the machine. For example, U.S. Pat. No. 4,944,193 to Harada et al. (“the '193 patent”) discloses an automatic transmission. Power from the engine enters a torque converter, which outputs to a drive shaft of the transmission. A plurality of frictional clutches positioned axially of each other react to provide different gear ratios. The plurality of clutches and planetary gear sets eliminate the need for additional countershafts.

Automatic transmissions, however, are preferred for many types of large truck and vocational truck applications. The automatic transmission provides improved shifting generally not available with the countershaft transmissions. The recreational vehicle operator is especially particular of the shift characteristics, demanding seamless, smooth shifting. The automatic transmission is capable of satisfying that demand. Similar particularity is growing in the long-haul and vocational vehicles industry, such as dump trucks and garbage trucks, where smooth shifts are desirable for driver comfort, control, and to decrease wear and damage due to hard shifts.

As a result, a need existed for the placement of PTO's on automatic transmissions. To satisfy this need, PTO's were place on a side of the automatic transmission and directly driven by a large gear connected to the input shaft. The '193 patent teaches a radially positioned PTO located on an outer side portion of the transmission housing.

Many automatic transmissions have been adapted to receive more than one PTO, and include a plurality of PTO pads, or interfaces, designed to interface a PTO. PTO pad locations vary by transmission manufacturer. Generally, the PTO pads are located at eight o'clock and one o'clock with respect to the circumference of the transmission housing.

However, large PTO's and corresponding large hydraulic pumps do not always fit on the PTO pads due to size restraints as a result of the frame rails, exhaust piping, cab constraints, large transmissions, and large engines. Often, to fit large PTO's, the engine must be repositioned, brackets built, and notches formed in vehicle components. Such drastic changes are undesirable as they affect the overall balance and structural integrity of the machine. Additionally, modifying original components is rarely preferred, and may result in denial of warranty claims.

To overcome the size constraints it is common to mount a PTO to a front of a vehicle. The front mounted PTO creates additional problems. For example, when mounted in the front location, the front bumper of the vehicle oftentimes must be extended to accommodate the usually large pumps. Further the radiators in such equipped vehicles frequently need to be cored or relocated to accommodate the mounting position of the hydraulic pump, which may result in decreased airflow to the radiator, a practice which may not be possible with the increased heat rejection of engines meeting stricter Environmental Protection Agency emissions laws. One option is to increase the size of the radiator. However, increasing the width makes the body larger, and increasing the height decreases the operator's field of vision. Consequently, the radiators must be made to extend lower, which cuts off the coupling between the crankshaft and forward mounted PTO's.

U.S. Pat. No. 6,263,749 also attempts to overcome the size constraints by providing an extended shaft capable of operably coupling an extended shaft to a side-mounted PTO and a pump. Unfortunately, this configuration suffers from the same drawbacks as discussed above with side mounted PTO's in that the size constraints may prevent the ability to attach such a large device to the transmission.

At least one additional problem common to all side mounted PTO's is the accessibility of the PTO pad. To attach the PTO to a side of the transmission may require either the removal of the transmission or the removal of the engine to gain access to the PTO pad. Neither option is desirable and both options are very expensive.

The present invention is directed to overcoming one or more of the problems as set forth above.

### SUMMARY OF THE INVENTION

According to one exemplary aspect of the present invention, an automatic transmission includes a transmission housing with a front and rear portion, an input member configured to rotate about a first axis, at least one planetary gear set having a sun gear, a ring gear, and carrier gears disposed between the sun gear and the ring gear, the at least one planetary gear set being driven by the input member, at least one brake and/or clutch adapted to change a gear ratio output from the transmission, and an output member rotating about the first axis. An input drive gear connected to the input member rotates about the first axis. A driven gear intermeshes the input drive gear and rotates about a second axis offset and parallel to the first axis. A mounting arrangement on the rear portion of the transmission is adapted to receive an auxiliary device and defines an aperture in coaxial alignment with the second axis.

According to another exemplary aspect of the present invention, a method of installing a power take-off shaft in an automatic transmission is provided. The transmission includes a transmission housing with a front and rear portion, an input member, at least one planetary gear set driven by the input member, and at least one brake or clutch adapted to change a gear ratio output from the transmission is provided. The method includes the steps of inserting the power take-off shaft into a bearing bore on the rear portion of the transmission housing and connecting one end of the power take-off shaft to a power take-off shaft receiver, inserting a bearing into the bearing bore on the rear portion of the transmission housing and onto the power take-off shaft, securing the power take-off shaft to the bearing, and securing the bearing to the transmission housing.

According to yet another exemplary aspect of the present invention, a power take-off kit for an automatic transmission to enable application of a power-take off device from a rear portion of a transmission housing is provided. The automatic transmission includes a transmission housing with a front and rear portion, an input member configured to rotate about a first axis, at least one planetary gear set having a sun gear, a ring gear, and carrier gears disposed between the sun gear and the ring gear, the at least one planetary gear set being driven by the input member, at least one brake and/or clutch adapted to change a gear ratio output from the transmission, and an output member rotating about the first axis. An input drive gear connected to the input member rotates about the first axis. A driven gear intermeshes the input drive gear and rotates about a second axis offset and parallel to the first axis. A mounting arrangement on the rear portion of the transmission is adapted to receive an auxiliary device and defines an aperture in coaxial alignment with the second axis. The kit includes a power take-off shaft, a bearing, a first fastener for securing the power take-off shaft to the bearing, and a second fastener for securing the bearing to the transmission housing.

It is to be understood that both the foregoing general description and the following detailed description are exemplary and explanatory only and are not restrictive of the invention.

### BRIEF DESCRIPTION OF THE DRAWINGS

FIG. 1 is an isometric view of a transmission having a rear-mounted power take-off and hydraulic pump according to an exemplary embodiment of the present disclosure; and

FIG. 2 is a cross-sectional isometric view of a transmission and driven assembly.

### DETAILED DESCRIPTION

Reference will now be made in detail to embodiments of the invention, examples of which are illustrated in the accompanying drawings.

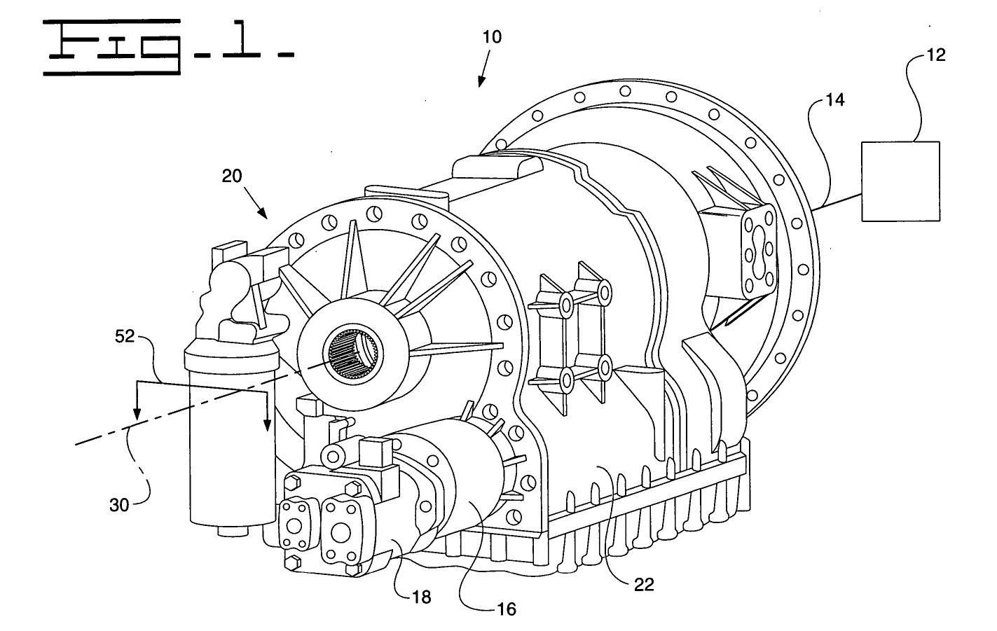

FIG. 1 illustrates a transmission 10 of an engine 12. The engine 12 may be, for example, an internal combustion engine or any other type of engine known in the art. The engine 12 and the transmission 10 may be mounted within an engine compartment of a work machine (not shown) and may be configured to supply power to elements of the work machine by any conventional means.

The transmission 10 may be connected to the engine 12 through any conventional means. In an exemplary embodiment, an input shaft, or input member 14 of the transmission 10 directly couples an output shaft of the engine 12 using, for example, a conventional torque converter (not shown).

A power take-off (“PTO”) 16 useful in supplying power to a pump assembly 18 mounts to a rear side of the transmission 10, specifically to a rear side 20 of the transmission case, or housing 22. The PTO 16 operates to drive the pump assembly 18 to supply hydraulic fluid to elements (not shown) of the work machine. In one embodiment, the pumping assembly 18, rather than the PTO 16, mounts directly to the rear portion 20 of the transmission 10 with a pump adapter. In such an embodiment, the pumping mechanism operates to supply hydraulic power to elements of the work machine, whenever the transmission 10 receives power. It is recognized that any type of auxiliary device, such as the PTO, the pump, or an electric motor/generator can be attached to the transmission housing 22.

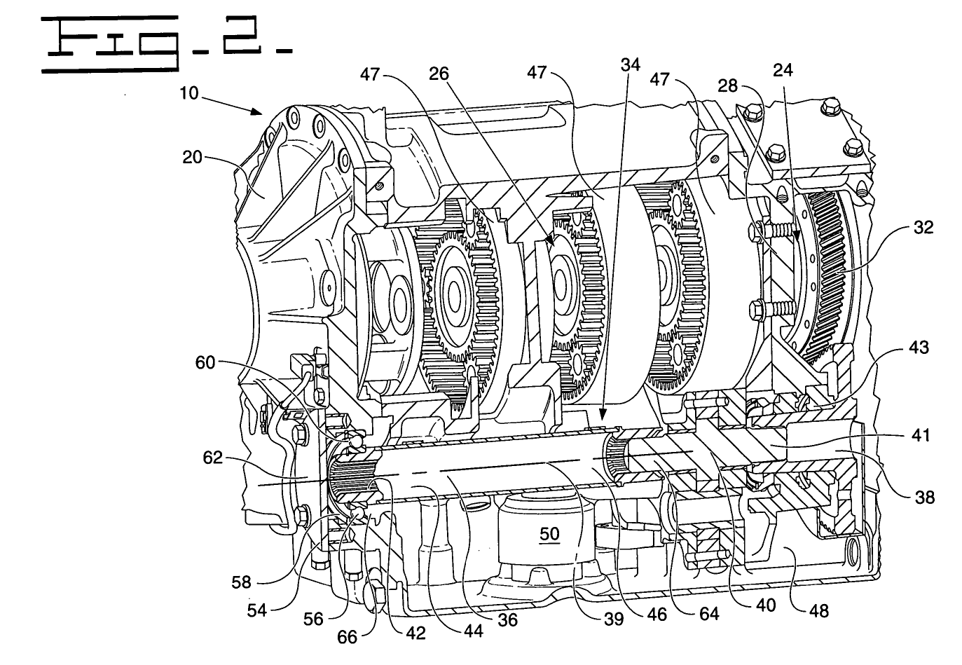

FIG. 2 illustrates a cross-sectional view of the transmission 10. The transmission 10 includes a first and second section 24 and 26 divided by a wall 28. On the first section 24 an input drive gear 32 directly couples the input shaft 14 such that the input drive gear 32 rotates at the same rotational speed as the input shaft 14 while the engine 12 is operating. The planetaries are positioned on the second section 26.

The input drive gear 32 drives a driven assembly 34 to transfer power from the engine 12 to the PTO 16. The driven assembly 34 may be a PTO drive shaft 36 connected to a driven gear 38, or alternatively, the PTO drive shaft 36 may be connected to a charge pump 40, which is driven by the driven gear 38 through a splined receiver 41. The driven assembly 34 is displaced from and parallel to a first axis 30 (See FIG. 1). The driven gear 38 rotates about a second axis 39. The PTO drive shaft 36 is configured with a spline 42, or the like, on a first end 44 to receive the PTO 16 so as to provide power thereto. Similarly, the PTO drive shaft 36 is splined on a second end 46 to connect to the charge pump 40 or the driven gear 38. The driven gear 38 passes through the wall 28 and is supported by bearings 43. The input drive gear 32 and the driven gear 38 may be sized and configured so as to drive the PTO 16 of the work machine at a desired rate. One skilled in the art will recognize that there are numerous gear ratios that can be accomplished by changing the size of the input drive gear 32 and the driven gear 38.

The transmission further includes a series of three planetary gear sets, clutches, brakes, and other automatic transmission components for automatic transmissions. The planetary gear sets rotate about the first axis 30, as is well known in the art. Similarly, the clutches and brakes function similar to clutches and brakes of other well-known automatic transmissions. The transmission includes two rotating clutches and three brakes. The input drives the sun gear of the first planetary, and a carrier of the third planetary drives the output member.

The charge pump 40 provides hydraulic power to elements throughout the transmission 10 for lubrication and/or clutch and brake engagement. The charge pump 40 is a gear pump to draw fluid from a sump 48 through a suction line 50. One skilled in the art will recognize that various types of charge pumps 40 exist and are well known in the art. It is envisioned that any type of charge pump 40 may be used in the current described configuration. The fluid leaves the charge pump 40 at a predetermined pressure to the oil filter (not shown) and through control valves to actuate the various clutches and brakes, and to lubricate the internal transmission components.

In an exemplary embodiment of the present invention, the driven assembly 34 is disposed below the first axis 30 (See FIG. 1) of the transmission 10. In particular, the driven assembly 34 and the PTO 16 may be disposed in a lower side quadrant of the transmission 10. It is envisioned, however, that the driven assembly 34, and the PTO 16 may be positioned at any location within the transmission housing 22. It is preferable, however, that the driven assembly 34, specifically the charge pump 40, be positioned where access is facilitated. In the illustrated embodiment, the driven assembly 34 is located below a horizontal plane 52 for easy access after the oil has been drained and an oil pan removed. If the driven assembly 34 is positioned at a location above the horizontal plane, it is envisioned that access holes, compartments, or lids may be used to facilitate access thereto.

As discussed above, the PTO drive shaft 36 may be a separate shaft with respect to the driven gear 38 and the charge pump 40. Advantageously, the PTO drive shaft 36 may be an optional component. Specifically, the transmission 10 can be manufactured and sold without the optional PTO drive shaft 36. Rather than having to buy a completely new transmission, a kit may be acquired containing the optional PTO drive shaft 36, a bearing 56, and two snap rings 58 and 60. One snap ring 58 secures the bearing 56 to the transmission housing 22 and the other snap ring 60 secures the PTO drive shaft 36 to the bearing 56. The PTO 16 fastens to a flange 54 on the rear portion 20 of the transmission 10. It is noted that any kind of mounting arrangement can used for attaching the PTO 16, or other auxiliary device, to the transmission housing 22. For example, the mounting arrangement may be any kind of bolt pattern provided in the transmission housing 22, as is well known to SAE standards.

To install the PTO drive shaft 36 post sale, the customer, dealer, or mechanic simply removes a PTO cover 62, inserts the first end 44 of the PTO drive shaft 36 into the bearing 56, secures the PTO drive shaft 36 to the bearing 56 with the snap ring 60, or other fastening device, such as a bolt, screw, clamp, clip, press, or permanent structure, and slides the spline of the second end 46 of the PTO drive shaft over a splined output member 64 of the charge pump 40 or receiver 41 of the driven member 38. It is noted that the PTO drive shaft 36 may be pressed into the bearing 56. It is further noted that the act of pressing the PTO drive shaft 36 into the bearing 56 may be equivalent to securing the PTO drive shaft 36 to the bearing 56. The snap ring 56 is configured to prevent significant axial movement of the PTO drive shaft 36 with respect to the bearing 56. The bearing 56 is pressed, or installed into a transmission bearing bore 66 of the housing 22, and secured with the snap ring 58, or other fastening device, such as a bolt, screw, clamp, clip, press, or permanent structure. It is noted again that the act of pressing the bearing 56 into the transmission bearing bore may be equivalent to securing the bearing 56 to the bearing bore 66. It may be necessary to heat the bearing bore 66 before installing the bearing 56 therein. The bearing bore 66 and flange 54 define an aperture with an axis coaxially aligned with the second axis 39. It is envisioned that the bearing 56 may be secured to the PTO drive shaft 36 and subsequently inserted into the bearing bore 66 and connected to the charge pump receiver 64 or receiver 41 of the driven gear 38.

The spline 42 on the first end 44 of the PTO drive shaft 36 is configured to receive the PTO 16. It is noted that the splines 42 may be internal or external, and may be any shape.

### INDUSTRIAL APPLICABILITY

Work machines known to use automatic transmissions of the type disclosed in the present invention have tight constraints due to the large size of the engine, the large size of the transmission, distance between the frame rails, exhaust routing pipes, and heavy duty suspension and steering components. On-highway trucking applications, as well as vocational vehicles, such as dump trucks, recreational vehicles, cement mixers, and garbage trucks are typical examples of the type of vehicle typical for application of the present invention. The transmission provides power to move the vehicle and the ability to mount a power take-off device to the rear of the transmission. Positioning the PTO 16 at the rear side 20 of the transmission 10 helps eliminate the need for machine modifications.

The PTO drive shaft 36 may be sold as an optional unit to decrease overall costs for users not in need of a rear-mounted PTO. The PTO drive shaft 36 may, however, be sold and purchased and easily installed at a later date if the user determines that a need exists. Additional components such as bearings and snap rings, or other fastening devices, may be used to hold the PTO drive shaft in position.

It will be apparent to those skilled in the art that various modifications and variations can be made without departing from the scope or spirit of the invention. Other embodiments of the invention will be apparent to those skilled in the art from consideration of the specification and practice of the invention disclosed herein. It is intended that the specification and examples be considered as exemplary only.

What is claimed is:

1. An automatic transmission comprising:
a transmission housing with a front and rear portion;
an input member configured to rotate about a first axis;
an output member rotating about the first axis;
at least one planetary gear driven by the input member and having at least one of a brake or clutch adapted to change a gear ratio output from the transmission;
an input drive gear connected to the input member and rotating about the first axis, the input drive gear configured to intermesh a driven gear offset from the first axis and configured to rotate about a second axis; and
a mounting arrangement on the rear portion of the transmission housing and adapted to receive an auxiliary device, the mounting arrangement defining an aperture in coaxial alignment with the second axis.

2. The automatic transmission according to claim 1, wherein the auxiliary device is selected from the group consisting of a power take-off device, a pump, and a generator.

3. The automatic transmission according to claim 1, the housing forming a wall between the input drive gear and the at least one planetary gear set.

4. The automatic transmission according to claim 1, further comprising:
a driven gear; and
a charge pump having a power take-off drive shaft receiver adapted to couple a power take-off drive shaft.

5. The automatic transmission according to claim 1, further comprising a cover removably fastened to the mounting arrangement adapted to seal the aperture.

6. The automatic transmission according to claim 1, wherein the driven gear and second axis are located in a lower quadrant of the transmission housing.

7. The automatic transmission according to claim 1, further comprising a power take-off shaft drivingly connected to the driven gear and extending into the rear portion of the transmission housing.

8. The automatic transmission according to claim 7, wherein the mounting arrangement includes a bearing around the second axis adapted to receive the power take-off shaft.

9. The automatic transmission according to claim 8, further comprising a fastener for connecting the bearing to the mounting arrangement.

10. The automatic transmission according to claim 9, wherein the fastener is a snap ring.

11. A method of installing a power take-off shaft in an automatic transmission having a transmission housing with a front and rear portion, an input member and an output member configured to rotate about a first axis, at least one planetary gear set being driven by the input member and having at least one of a brake or clutch adapted to change a gear ratio output from the transmission, an input drive gear connected to the input member and rotating about the first axis, a driven gear intermeshing the input drive gear and rotating about a second axis offset and parallel to the first axis, and a mounting arrangement on the rear portion of the transmission and adapted to receive an auxiliary device, the mounting arrangement defining an aperture in coaxial alignment with the second axis, the method comprising the steps of:
inserting the power take-off shaft into a bearing bore on the rear portion of the transmission housing and connecting one end of the power take-off shaft to a power take-off shaft receiver;
inserting a bearing into the bearing bore on the rear portion of the transmission housing and onto the power take-off shaft;
securing the power take-off shaft to the bearing; and
securing the bearing to the transmission housing.

12. The method of claim 11, wherein the steps are performed in the order as written.

13. The method of claim 11, wherein the power take-off shaft is secured to the bearing using a snap ring.

14. The method of claim 11, wherein the bearing is secured to the transmission housing with a snap ring.

15. The method of claim 11, wherein the power-take off shaft is secured to the bearing with a friction fit resulting from simultaneously inserting the power-take off shaft into the bearing.

16. The method of claim 11, wherein the bearing is secured to the transmission housing with a friction fit resulting from simultaneously inserting the bearing into the transmission housing.

17. The method of claim 11, before inserting the power take-off shaft, the step of removing a cap from a flange on the rear portion of the transmission housing.

18. The method of claim 11, wherein the power take-off shaft is press fit into the bearing.

19. The method of claim 11, wherein the power take-off shaft connects to the power take-off shaft receiver of the charge pump.

20. The method of claim 11, wherein the power take-off shaft connects to the power take-off shaft receiver of a driven gear.

21. A power take-off kit for an automatic transmission having a transmission housing with a front and rear portion, an input member and an output member configured to rotate about a first axis, at least one planetary gear set being driven by the input member and having at least one of a brake or clutch adapted to change a gear ratio output from the transmission, an input drive gear connected to the input member and rotating about the first axis, a driven gear intermeshing the input drive gear and rotating about a second axis offset and parallel to the first axis, and a mounting arrangement on the rear portion of the transmission and adapted to receive an auxiliary device, the mounting arrangement defining an aperture in coaxial alignment with the second axis, the kit comprising:
a power take-off shaft adapted to be received within the aperture and drivingly connect to the drive gear;
a bearing for providing smooth rotational movement of the power take-off shaft;
a first fastener for securing the power take-off shaft to the bearing; and
a second fastener for securing the bearing to the transmission housing.

22. The power take-off kit according to claim 21, wherein the first and second fasteners are snap rings.

23. The power take-off kit according to claim 21, wherein, the driven gear is integral to the power take-off shaft.

24. The power take-off kit according to claim 21, wherein the driven gear includes a power take-off shaft receiver.

25. The power take-off kit according to claim 24, wherein the power take-off shaft connects to the power take-off shaft receiver.
